(19) United States
(12) Patent Application Publication
(10) Pub. No.: US 2014/0322786 A1
(43) Pub. Date: Oct. 30, 2014

(54) POLYMER MODIFIED SUBSTRATES, THEIR PREPARATION AND USES THEREOF

(71) Applicant: APCETH GMBH & CO. KG, München (DE)

(72) Inventors: Frank Deubel, Munchen (DE); Bernhard Rieger, Oberelchingen (DE); Stephan Salzinger, Munchen (DE); Ning Zhang, Garching (DE)

(73) Assignee: APCETH GMBH & CO KG, Munchen (DE)

(21) Appl. No.: 14/358,430

(22) PCT Filed: Nov. 13, 2012
(86) PCT No.: PCT/EP2012/072488

§ 371 Date: May 15, 2014

(30) Foreign Application Priority Data
Nov. 15, 2011 (EP) 11189156.0

(51) Int. Cl. C08F 265/06; C08F 265/04; B05D 3/00

(52) U.S. Cl. CPC C08F 265/06; B05D 3/007; C08F 265/04; B05D 2350/60; B05D 2502/005
USPC 435/180; 427/372.2; 435/396; 525/287; 525/309

(57) ABSTRACT

Provided are polymer modified substrates which comprise a) a substrate, b) a binding layer covalently attached to the surface of the substrate and covering at least a part of this surface; and c) a polymer brush formed by a plurality of polymer chains, each of which is covalently attached at one of its terminals to the binding layer. Moreover, methods are provided, for the preparation of the polymer modified substrates by polymerizing vinyl group containing monomers, such as vinylphosphonates, on a binding layer provided on a substrate.

The modification of surfaces with polymer layers to provide protection and/or a specific functionality is widely used. For the application of polymer films, a variety of techniques is available, including the application of polymer solutions, the polymerization of monomers directly on the surface and/or the grafting of polymers carrying reactive groups onto the surface. Using the latter approach, surface coatings can be obtained, wherein polymer chains are at least partly arranged perpendicularly to the surface. Such surface coatings generally provide chemical and mechanical robustness as we'll as synthetic flexibility towards the introduction of functional groups (S. Edmondson et al., Chem. Soc. Rev., 2004, 33, 14-22). In particular polymer brushes represent an efficient strategy to prepare stable coatings (J. B. Kim et al., Polymer. Brushes: Synthesis, Characterization, Applications; Wiley-VCH: Weinheim, Germany, 2004).

Over the past decades, phosphorus containing polymers have attracted great interest on account of their halogen-free flame retardant properties, proton-conducting characteristics, and commercial application as binders in dental or bone concrete. Much attention has recently been drawn to biomedical applications in e.g. anti-fouling, tissue engineering, drug delivery, and cell proliferation surfaces (R. A. Gemeinhart et al., J. Biomed. Mater. Res., Part A 2006, 78A, 433-444) due to the low toxicity and biocompatibility of these polymers (S. Monge et al., Biomacromolecules 2011, DOI: 10.1021/bm2004803). It was shown that poly(vinyl-phosphonates) with high molar mass and low polydispersity suitable for the above applications can be efficiently prepared in the presence of rare earth metal-containing catalysts following a Group Transfer Polymerization (GTP) mechanism (U. B. Seemann et al., Angew. Chem. Int. Ed. 2010, 49, 3489-3491).

However, for many applications these polymers are required to stably attach to surfaces, ideally through covalent bonds, to increase the mechanical stability and the durability of the modified surface. While suggestions have been made to modify nanoparticles (WO 2008/071286) or other surfaces (WO 02/10759) with polymers that may contain polyphosphonate moieties, no coating structures have been reported which allow the provision of polymer brushes containing phosphorous functionalities with suitable thickness and/or density on stably modified surfaces. This may be due to the fact that radical or ionic approaches, which are frequently used for the grafting of polymer chains from surfaces (e.g. R. Jordan and A. Ulman, J. Am. Chem. Soc. 1998, 120, 243-247; R. Jordan et al., J. Am. Chem. Soc. 1999, 121, 1016-1022 disclosing ionic polymerization, or X. Huang and M. J. Wirth, Anal. Chem. 1997, 69, 4577-4580 disclosing free/controlled radical polymerization) usually afford low yields and degrees of polymerization if applied to the polymerization of vinylphosphonates (cf. T. Wagner et al., Macromol. Chem. Phys. 2009, 210, 1903-1914; B. Bingöl et al., Macromolecules 2008, 41, 1634-1639).

Thus, it was the aim of the inventors to provide polymer modified surfaces which stably modify the underlying substrate material by polyphosphonates and related polymer moieties, and which can be efficiently prepared at advantageous surface coverages.

This aim could be achieved by a new approach, wherein the substrate is provided with a binding layer covalently attached to the surface which provides free vinyl groups. Subsequently, a rare earth metal mediated polymerization of suitable vinyl monomers is carried out, which uses the vinyl groups in the binding layer as attachment sites and initiation sites for the formation of polymer chains in a polymer brush. In accordance with this method, the polymer chains can be efficiently grafted from the substrate surface, and can form polymer brushes with appropriate chain densities and thicknesses.

As a result, the present invention provides a process for the preparation of a polymer-modified substrate, the process comprising the steps of
a) preparing on at least a part of the surface of the substrate a binding layer covalently attached to the substrate and carrying a plurality of vinyl groups substituted by an electron accepting group;
b) contacting the binding layer with a rare earth metal complexes as catalysts and allowing the rare earth metal complexes to coordinate with the vinyl groups substituted by an electron accepting group of the binding layer;
c) contacting the binding layer including the coordinated rare earth metal complex catalysts with vinyl monomers containing a vinyl group substituted with an electron accepting group; and
d) carrying out a polymerization of the vinyl monomers mediated by the rare earth metal of the coordinated rare earth metal complex to form polymer chains covalently attached at one of their terminals to the binding layer.

In accordance with a preferred embodiment, the binding layer is prepared by a process wherein step a) comprises the steps
a1) of providing on the surface of the substrate binder molecules each carrying at least two vinyl groups each substituted by an electron accepting group; and
a2) of preparing the binding layer by surface grafting and polymerizing the binder molecules on the surface of the substrate.

The rare earth metal complexes used in the process in accordance with the invention preferably comprise a metal selected from the group consisting of yttrium, gadolinium, terbium, dysprosium, holmium, erbium, thulium, ytterbium, and lutetium. Moreover, it has been found to be advantageous if the rare earth metal complexes are trivalent rare earth metal complexes comprising a rare earth metal atom coordinated by at least two cyclopentadienyl ligands.

The invention also provides a polymer-modified substrate obtainable by the process in accordance with the invention, said polymer-modified substrate comprising
(a) a substrate,
(b) a binding layer covalently attached to the surface of the substrate and covering at least a part of this surface; and
(c) a polymer brush formed by a plurality of polymer chains, each of which is covalently attached at one of its terminals to the binding layer.

In accordance with a preferred embodiment, the polymer-modified substrate obtainable by the process in accordance with the invention comprises:
a) a substrate,
b) a binding layer covalently attached to the surface of the substrate and covering at least a part of this surface which is obtainable by providing on the surface of the substrate binder molecules, each carrying at least two vinyl groups substituted by an electron accepting group, and surface grafting and polymerizing the binder molecules on the surface of the substrate to form the binding layer; and
c) a polymer brush formed by a plurality of polymer chains, each of which is covalently attached at one of its terminals to the binding layer.

The polymer chains of the polymer brush preferably comprise polymerized units selected from the group consisting of vinylphosphonate units, vinylphosphonic acid units, (meth)acrylate units, (meth)acrylic acid units and combinations thereof, in particular selected from the group consisting of vinylphosphonate units, vinylphosphonic acid units, and combinations thereof. For example, the polymer chains may comprise homopolymer chains of polymerized vinylphosphonate units or vinylphosphonic acid units. Particularly suitable vinylphosphonate units which may be polymerized in vinylphosphonate homopolymer or copolymer chains in accordance with the invention are units selected from dimethyl vinylphosphonate, diethyl vinylphosphonate and dipropyl vinylphosphonate.

Furthermore, the invention also encompasses uses of the binding layer in combination with the polymer brushes as defined above, e.g. to impart flame retardant properties, anti-fouling properties, and/or biocompatibility to the surface of a substrate. It will be understood that, along the same line, the use of the polymer modified substrates in applications where flame retardant properties, anti-fouling properties, and/or biocompatibility are required, is also encompassed by the invention. Similarly, the invention encompasses processes wherein the advantageous properties of the modified surfaces can be exploited, such as a process for the expansion of cells, particularly stem cells, comprising the step of contacting the cells with a substrate in accordance with the invention.

Moreover, a binding layer-modified substrate comprising a substrate and a binding layer covalently attached to the surface of the substrate and covering at least a part of this surface, wherein the binding layer is obtainable by providing on the surface of the substrate binder molecules, each carrying two vinyl groups substituted by an electron accepting group and surface grafting and polymerizing the binder molecules on the surface of the substrate, is also part of the invention. Such a binding-layer modified substrate forms a useful intermediate product for the provision of the final polymer modified substrate.

The term “alkyl” as used herein, unless otherwise indicated in a specific context, encompasses straight and branched alkyl moieties. Preferred examples of alkyl groups have 1 to 6 carbon atoms (C₁₋₆ alkyl), in particular 1 to 4 carbon atoms (C₁₋₄ alkyl), and include methyl, ethyl, propyl (e.g., n-propyl, or isopropyl) and butyl (e.g., n-butyl, isobutyl, tert-butyl, or sec-butyl).

The term “heteroalkyl”, unless otherwise indicated in a specific context, refers to an alkyl group and its preferred embodiments as described above, wherein one or more of the carbon atoms have been replaced by a heteroatom, including the possibility of replacement of a carbon atom at one or both of then terminals of the alkyl group. Preferred examples of heteroatoms are O, S and N, in particular O. Preferred examples of heteroalkyl groups contain 2 to 6 carbon atoms and 1, 2 or 3 heteroatoms. Thus, preferred heteroalkyl groups are ether groups which may contain one or more, such as 1, 2 or 3, ether linkages.

The term “cycloalkyl”, unless otherwise indicated in a specific context, refers to a cyclic alkyl moiety. Preferred examples of suitable alkyl groups have 4 to 10 carbon atoms, in particular 5 or 6 carbon atoms, and include cyclopentyl and cyclohexyl.

The term “heterocycloalkyl”, unless otherwise indicated in a specific context, refers to a cycloalkyl group in which one or more of the carbon atoms have been replaced by a heteroatom. Preferred examples of heteroatoms are N, O and S. Preferred examples of heterocycloalkyl groups contain 2 to 5 carbon atoms and 1, 2 or 3 heteroatoms. Further preferred examples of heterocycloalkyl groups include pyrrolidine, tetrahydrofuran or piperidine groups.

The term “aryl”, unless otherwise indicated in a specific context, refers to an aromatic ring system, including single rings and condensed rings, which preferably has 6 to 10 carbon atoms. Particular examples are a phenyl or a naphthyl group.

The term “heteroaryl”, unless otherwise indicated in a specific context, refers to an aryl group as defined above in which one or more of the carbon atoms, e.g. 1, 2 or 3, have been replaced by a heteroatom. Preferred examples of heteroatoms are N, O or S. Preferred examples of heteroaryl groups contain 3 to 9 carbon atoms and 1, 2 or 3 heteroatoms. Further preferred examples of heteroaryl groups include pyrrole, pyridine, pyrazole, pyrazine, furan and thiophene groups.

The term “alkoxy”, unless otherwise indicated in a specific context, refers to the group —O— alkyl, wherein alkyl is defined as above.

The term “acyl” refers to the group alkyl-C(O)—, wherein alkyl is defined as above.

The term “aralkyl” refers to an alkyl group as defined above, substituted by an aryl group as defined above.

The term “halogen”, unless otherwise indicated in a specific context, denotes F, Cl, Br or I, preferably F, Cl or Br.

The term “carboxylic acid group”, unless otherwise indicated in a specific context, encompasses both the protonated form —COOH and the anionic form thereof.

In the terms “(meth)acrylate” and “(meth)acrylic acid”, the brackets indicate in accordance with common practice that the methyl group may be present or absent.

Any optionally substituted alkyl, heteroalkyl, cycloalkyl, heterocycloalkyl, aryl, heteroaryl, or alkoxy group, either referred to as such or as part of another group (such as the alkyl moiety of an aralkyl group), can be substituted with one or more, such as 1, 2 or 3, substituents e.g. selected from halogen, hydroxy, —NH₂, —NH(C₁₋₆ alkyl) or —N(C₁₋₆ alkyl)₂. Preferred are F, Cl, hydroxy and —NH₂. Any optionally substituted cycloalkyl, heterocycloalkyl, aryl or heteroaryl group, either referred to as such or as part of another group (such as the aryl moiety of an aralkyl group), can be substituted with one or more, such as 1, 2 or 3, substituents e.g. selected from C₁₋₆ alkyl, C₁₋₆ alkoxy, halogen, hydroxy, —NH₂, —NH(C₁₋₆ alkyl) or —N(C₁₋₆ alkyl)₂. Preferred are methyl, ethyl, methoxy, ethoxy, F, Cl, hydroxy and —NH₂. General preference is given to the case where the optionally substituted moieties are unsubstituted, unless indicated otherwise in a specific context.

The term “vinyl group” is used herein in accordance with a common practice in the field of polymer sciences to refer to a group wherein two carbon atoms are linked by a double bond, one of which carries two hydrogen atoms (also referred to as a methylidene moiety, ═CH₂). It includes such groups which carry a non-hydrogen substituent at the other carbon atom. Thus, the vinyl group can be illustrated by the following formula:

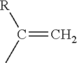

wherein R can be hydrogen or another atom or group, such as an electron accepting group (e.g. selected from an ester group, an amide group, an aldehyde group and an acyl group), an alkyl group, or any other group suitable for the given purpose, such as a heteroalkyl, cycloalkyl, heterocycloalkyl, aryl, heteroaryl, alkoxy or aralkyl group, all of which may be optionally substituted, or a halogen. It will be understood that the open valency marked by a simple dash indicates the bond which connects the vinyl group to the remainder of the molecule. In the case of a vinyl group or a vinyl monomer substituted by an electron accepting group, the electron accepting group may also form this remainder of the molecule or a part of it. In the latter case, it is preferred that R is a group different from an electron accepting group, such as hydrogen or alkyl. Furthermore, it will be understood that, if reference is made herein to a vinyl group substituted by an electron accepting group, the electron accepting group leaves the ═CH₂ moiety of the vinyl group intact and is attached to the other carbon atom linked by the double bond.

As noted above, the polymer modified substrates in accordance with the invention comprise on at least a part of the surface thereof a binding layer which is covalently attached to the surface of the substrate. Typically, the binding layer is formed from binder molecules which provide a functional group which allows the covalent attachment of the binding layer to the surface of the substrate, and which carry at the same time a vinyl group substituted by an electron accepting group acting as attachment site and initiation site for the polymer chain forming the polymer brush together with neighbouring polymer chains.

In accordance with a first exemplary embodiment, the binding layer represents a monolayer formed by a plurality of binder molecules covalently attached to the surface of the substrate and carrying a vinyl group substituted by an electron accepting group at a terminal close to the surface of the monolayer pointing away from the substrate. A typical structure of these binder molecules of the first exemplary embodiment can be illustrated by the following formulae (Ia) and (Ib), among which preference is given to the binder molecules of formula (Ib).

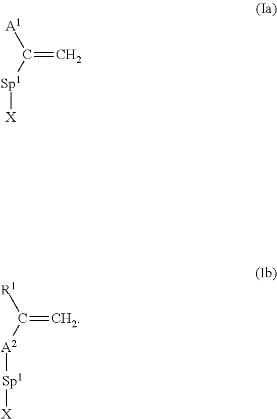

In formula (Ia), A¹ is an electron accepting group selected from an ester group, an amide group, an aldehyde group, an acyl group, a —COOH or a nitrile group, preferably an ester group, an amide group, an aldehyde group or an acyl group, and in particular an ester group. Preferred as ester group is a group —C(O)OR². Preferred as amide group is a group —C(O)NR³R⁴. R² is selected from alkyl, cycloalkyl and aryl which are optionally substituted. Preferred is alkyl and aryl, in particular alkyl. R³ and R⁴ are independently selected from hydrogen and from alkyl, cycloalkyl and aryl which are optionally substituted. Preferred is alkyl and aryl, in particular alkyl. Hydrogen is a less preferred option.

Sp′ is a divalent spacer moiety, such as a divalent alkyl group or a divalent heteroalkyl group. Particular examples are a C₃ to C₁₂ alkyl group, or such a group containing one or more, such as 2 or 3 ether bonds interspersed between its C atoms.

X is a functional group which allows the covalent attachment of the binder molecule to the surface of the substrate. Suitable functional groups for the attachment of surface coatings to diverse surfaces are well known in the art. They include, for example, a group —Si(R⁵)₃, wherein R⁵ is selected from an alkoxy group, in particular a methoxy or ethoxy group, or from a halogen, in particular Cl. As further examples for group X, thiol groups (—SH) or phosphonate groups (—P(O)(OH)₂) in the form of their mono- or dianion can be mentioned. The group —Si(R⁵)₃ is generally preferred and can be conveniently used e.g. for the modification of surfaces like glass or silicon.

In formula (Ib), A² is an electron accepting group selected from an ester (—C(O)O—), an amide or a carbonyl (—C(O)—) group. Preferred is an ester group. For the ester and the amide group, it is preferred that the C═O moiety is bound directly to the C-atom forming the C—C double bond of the vinyl group. Preferred as amide group is a group —C(O)NR³—, wherein R³ is selected from hydrogen and from alkyl, cycloalkyl and aryl which are optionally substituted. Preferred is alkyl and aryl, in particular alkyl. R¹ is selected from hydrogen and from alkyl, heteroalkyl, cycloalkyl, heterocycloalkyl, aryl, heteroaryl and aralkyl which are optionally substituted. Preferred for R¹ is hydrogen or alkyl, such as methyl, ethyl or propyl, and particularly preferred is hydrogen or methyl. Sp¹ and X are defined as in formula (Ia).

In accordance with a preferred second exemplary embodiment for the formation of the binding layer, binder molecules are used which carry at least two vinyl groups, and wherein each of the vinyl groups is substituted by an electron accepting group. The vinyl groups allow reactions between the binder molecules and between the surface of the substrate to take place. In this case, the binding layer can be prepared by providing on at least a part of the surface of the substrate binder molecules each carrying at least two vinyl groups each substituted by an electron accepting group; and preparing the binding layer by surface grafting and polymerizing the binder molecules on the surface of the substrate. It has been found that binder molecules carrying at least two vinyl groups, wherein each of the vinyl groups is substituted by an electron accepting group, are particularly useful for providing a binding layer in the context of the present invention. These binder molecules may contain, for example, 2, 3 or 4 of the vinyl groups, but binder molecules carrying two vinyl groups are generally preferred. It is also possible to use mixtures of binder molecules containing different numbers of vinyl groups. In this case, it is preferred that at least 50%, more preferably at least 80% of the binder molecules carry two vinyl groups. By changing the number of vinyl groups in some or all of the binder molecules, it is possible to adapt the number of branching points and/or the density of the crosslinks formed in the binding layer. It is also possible during the preparation of the binding layer to mix the binder molecules carrying at least two vinyl groups with molecules carrying only a single vinyl group substituted with an electron accepting group to control the density of the formed network or the density of the vinyl groups available for attachment of the polymer brushes in the binding layer.

The vinyl groups contained in the binder molecules of this second embodiment allow a reaction of binder molecules with a substrate surface, such as a substrate surface providing hydrogen atoms bound at the surface. At the same time, they can be polymerized in intermolecular reactions between the binder molecules as monomers to provide a binding layer in the form of a polymer layer. In fact, due the presence of two polymerizable vinyl groups, branched and/or covalently crosslinked polymer structures can be provided in the binding layer, such that a stable polymeric binding layer can be formed from the binder molecules. Typically, the binding layer in accordance with this embodiment contains branched polymer chains. By increasing the number of vinyl groups, e.g. through the use of multifunctional binder molecules with more than two vinyl groups, the formation of crosslinks can be promoted. And finally, vinyl groups which do not react during the surface grafting and polymerization reaction and remain in the initial binding layer can be used as sites for the attachment of polymer chains. It will thus be understood that a plurality of vinyl groups substituted with an electron accepting group will be present after the binding layer has been formed on the surface of the substrate.

The two or more vinyl groups substituted with an electron accepting group in one binder molecule may be identical or different. In view of the simplicity of the synthesis, it may be preferable that two identical groups are contained in the binder molecules. For a controlled formation of the binding layer, it is preferred that the binder molecules contain, apart from the vinyl group substituted with an electron accepting group, no additional non-aromatic C—C double bond, or no additional double bond at all.

The vinyl groups in the binder molecules of the second embodiment are also substituted with an electron accepting group. It will be understood by the skilled reader that this substitution leaves the vinyl characteristics of the group intact, i.e. the electron accepting group is bound to the non-terminal carbon atom of the vinyl group. Suitable electron accepting groups include an ester group, amide group, carbonyl group (including an acyl and an aldehyde group), a —CN and a —COOH group. Preferred is an ester group, an amide group, an aldehyde group or an acyl group, and in particular an ester group.

Thus, preferred vinyl groups substituted with an electron accepting group in the binder molecules in accordance with the second embodiment have one of the following structures (IIa) or (IIb):

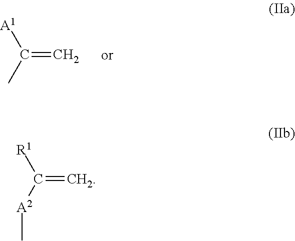

In formula (IIa), A¹ is an electron accepting group selected from an ester group, an amide group, an aldehyde group, an acyl group, a —COOH or a nitrile group, preferably an ester group, an amide group, an aldehyde group or an acyl group, and in particular an ester group. Preferred as ester group is a group —C(O)OR². Preferred as amide group is a group —C(O)NR³R⁴. R² is selected from alkyl, cycloalkyl and aryl which are optionally substituted. Preferred is alkyl and aryl, in particular alkyl. R³ and R⁴ are independently selected from hydrogen and from alkyl, cycloalkyl and aryl which are optionally substituted. Preferred is alkyl and aryl, in particular alkyl. Hydrogen is a less preferred option. It will be understood that the open valency marked by a simple dash indicates the bond which connects the vinyl group to the remainder of the molecule.

In formula (IIb), A² is an electron accepting group selected from an ester (—C(O)O—), an amide or a carbonyl (—C(O)—) group. Preferred is an ester group. For the ester and the amide group, it is preferred that the C═O moiety is bound directly to the C-atom forming the C—C double bond of the vinyl group. Preferred as amide group is a group —C(O)NR³—, wherein R³ is selected from hydrogen and from alkyl, cycloalkyl and aryl which are optionally substituted. Preferred is alkyl and aryl, in particular alkyl. Hydrogen is a less preferred option. R¹ is selected from hydrogen and from alkyl, heteroalkyl, cycloalkyl, heterocycloalkyl, aryl, heteroaryl and aralkyl which are optionally substituted. Preferred for R¹ is hydrogen or alkyl, such as methyl, ethyl or propyl, and particularly preferred is hydrogen or methyl.

In terms of their convenient availability, preferred vinyl groups substituted with an electron accepting group are those of formula (IIb), in particular (meth)acrylate groups, connected via an ester bond formed by the carboxylic acid group of the (meth)acrylate to the remainder of the binder molecule. Most preferred are methacrylate groups in this context.

The two or more vinyl groups substituted with an electron accepting group in the binder molecules of the second embodiment are generally attached to a n-valent spacer moiety, wherein n represents the number of vinyl groups in the binder molecule. There are little restrictions imposed on this spacer moiety. It will be understood that it should preferably be inert in the surface grafting and polymerization reaction which is carried out to prepare the binding layer from the binder molecules. For example, the spacer moiety can be an n-valent group selected from a n-valent alkyl, heteroalkyl, cycloalkyl, heterocycloalkyl, aryl, heteroaryl and aralkyl group, all of which can be optionally substituted. Alkyl and heteroalkyl groups are preferred. Particular preferred are binder molecules carrying two vinyl groups linked by a divalent ethylene, propylene or butylene group.

Thus, the preferred structure of the binder molecules in the context of the second embodiment for the formation of a binding layer can be illustrated by the following formulae (IIIa) or (IIIb):

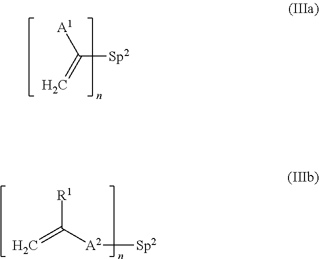

In formula (IIIa), A¹ is an electron accepting group selected from an ester group, an amide group, an aldehyde group, an acyl group, a —COOH or a nitrile group, preferably an ester group, an amide group, an aldehyde group or an acyl group, and in particular an ester group. Preferred as ester group is a group —C(O)OR². Preferred as amide group is a group —C(O)NR³R⁴. R² is selected from alkyl, cycloalkyl and aryl which are optionally substituted. Preferred is alkyl and aryl, in particular alkyl. R³ and R⁴ are independently selected from hydrogen and from alkyl, cycloalkyl and aryl which are optionally substituted. Preferred is alkyl and aryl, in particular alkyl. Hydrogen is a less preferred option. n is 2, 3 or 4, preferably 2. Sp² is an n-valent linker moiety, selected from a divalent alkyl, heteroalkyl, cycloalkyl, heterocycloalkyl, aryl, heteroaryl and aralkyl group, all of which can be optionally substituted. Alkyl and heteroalkyl groups are preferred. Particular preferred are an ethylene, propylene or butylene group.

For the binder molecules of formula (IIIb), which are generally preferred among the binder molecules of formula (IIIa) and (IIIb), A² is an electron accepting group selected from an ester (—C(O)O—), an amide or a carbonyl (—C(O)—) group. Preferred is an ester group. For the ester and the amide group, it is preferred that the C═O moiety is bound directly to the C-atom forming the C—C double bond of the vinyl group. Preferred as amide group is a group —C(O)NR³—, wherein R³ is selected from hydrogen and from alkyl, cycloalkyl and aryl which are optionally substituted. Preferred is alkyl and aryl, in particular alkyl. Hydrogen is a less preferred option. R¹ is selected from hydrogen and from alkyl, heteroalkyl, cycloalkyl, heterocycloalkyl, aryl, heteroaryl and aralkyl which are optionally substituted. Preferred for R′ is hydrogen or alkyl, such as methyl, ethyl or propyl, and particularly preferred is hydrogen or methyl. n and Sp² are defined as in formula (IIIa).

In view of its commercial availability, ethylene glycol dimethacrylate can be conveniently used as a binder molecule of this second embodiment.

As noted above, the process for the formation of a polymer modified substrate in accordance with the invention comprises the step of preparing, on at least a part of the surface of the substrate, a binding layer covalently attached to the substrate and carrying a plurality of vinyl groups each substituted by an electron accepting group. The binding layer can be favourable prepared by providing on the surface of the substrate binder molecules, e.g. those of the above first or second exemplary embodiment, or mixtures of the binder molecules of the first and the second embodiment.

In accordance with, a preferred embodiment, the binding layer is prepared by a process comprising the steps of providing on the surface of the substrate binder molecules each carrying at least two vinyl groups each of which is substituted by an electron accepting group, such as the binder molecules of the second exemplary embodiment explained above, and of preparing the binding layer by surface grafting and polymerizing the binder molecules on the surface of the substrate. Thus, the binding layer is covalently attached to the surface of the substrate. Additionally, the binding layer formed in this manner generally comprises a branched and/or crosslinked polymer network formed by the polymerization reaction of the binder molecules carrying the two vinyl groups substituted by an electron accepting group, which two vinyl groups correspond to two polymerizable groups per binder molecule.

It will be understood that those vinyl groups in the binder molecules which take part in the surface grafting and polymerization reaction will no longer remain vinyl groups after the reaction, but will form a covalent bond to the surface of the substrate or to another polymerized vinyl group, accompanied by the loss of the respective vinyl double bond. Furthermore, it will be understood that not all of the binder molecules in the binding layer obtained via surface grafting and polymerization need to form a bond to the surface of the substrate in order for the binding layer to be attached to the surface. Generally, the predominant amount of the binder molecules will react with one or two other binder molecules to form a network of binder molecules.

After the formation of the preferred binding layer by surface grafting and polymerization and before the formation of the polymer brush, a plurality of vinyl groups will remain in the binding layer to allow the coordination of the catalyst complexes subsequently mediating the formation of the polymer chains. These remaining vinyl groups will generally be distributed throughout the binding layer before the polymer chains are attached to the binding layer. Similarly, the binding molecules of the above first exemplary embodiment will provide a binding layer, containing a plurality of vinyl groups substituted by an electron accepting group, typically in the form of a monolayer of the binder molecules. However, in the final polymer modified substrate, vinyl groups of the binding layer do not need to be present any more, and are in fact preferably transformed completely (or essentially completely) during the formation of the polymer chains.

Depending on the intended use of the polymer-modified substrate, the binding layer can cover the substrate surface fully or partially. A partial coverage can be achieved, e.g., by forming regular or irregular patterns of the binder molecules on the substrate. Techniques for the formation of such patterns are established in the art and include the selective application via a brush, etc. or via ink-jet technologies. Alternatively, hydrophilic or hydrophobic properties can be imparted to parts of the surface by known printing techniques, and subsequently the binder molecules can be applied in neat form, especially if they are liquids, or in suitable solvents.

The thickness of the binding layer is not limited. However, in view of the fact that the binder layer is merely intended to ensure the bonding of the polymer chains foaming the polymer brush on the surface, it may not be efficient to use an exceedingly thick binding layer. Good results could be obtained for thicknesses in the range of 5 to 100 nm, preferably 10 to 50 nm. The thickness can be conveniently determined via atomic force microscopy (AFM) or ellipsometry after the surface grafting and polymerization reaction, before the polymer brush is formed on the binding layer.

It is possible for the binding layer to contain other molecules apart from binder molecules mentioned above. However, generally the binder molecules defined above amount for at least 50 mol %, preferably at least 70 mol % and more preferably at least 90 mol % of all molecules forming the binding layer. It may be convenient to form the binding layer only from the binder molecules of the first or of the second embodiment as they are described above.

The polymer chains forming the polymer brush attached to the binding layer are obtainable by the polymerization reaction of vinyl monomers carrying a vinyl group substituted with an electron accepting group (cf. the general explanation given with respect to the meaning of the term above). Generally, the polymer chains formed by the polymerization of these vinyl groups have a carbon backbone, i.e. the longest chain extending from the point of attachment at the binding layer is formed only by carbon-carbon bonds.

Preferred vinyl monomers carrying a vinyl group substituted with an electron accepting group have the following structures

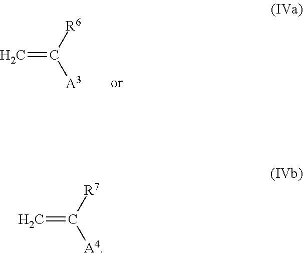

In formula (IVa), R⁶ is selected from hydrogen and from alkyl, heteroalkyl, cycloalkyl, heterocycloalkyl, aryl, heteroaryl and aralkyl which are optionally substituted. Preferred for R⁶ is hydrogen or alkyl, such as methyl, ethyl or propyl, and particularly preferred is hydrogen or methyl. A³ is an electron accepting group selected from an ester group, an amide group, an aldehyde group, an acyl group, from corresponding structures wherein an oxo group ═O and/or an ether group —O— is replaced by sulfur, and from a nitro group (—NO₂). The corresponding sulfur groups are, for example, selected from —C(S)SR⁸, —C(O)SR⁸ and —C(S)R⁸. Preferred as A³ is a group selected from an ester group, an amide group, an aldehyde group or an acyl group, and more preferred is an ester group. Preferred as ester group is a group —C(O)OR⁸. Preferred as amide group is a group —C(O)NR⁹R¹⁰ . R⁸ is selected from alkyl, cycloalkyl and aryl which are optionally substituted. Preferred is alkyl and aryl, in particular alkyl. R⁹ and R¹⁰ are independently selected from hydrogen and from alkyl, cycloalkyl and aryl which are optionally substituted. Preferred are alkyl and aryl, in particular alkyl. Hydrogen is a less preferred option.

Particularly preferred vinyl monomers of formula (IVa) in terms of their convenient availability are (meth)acrylates, in particular methacrylates such as methyl methacylate.

In formula (IVb), R⁷ is selected from hydrogen and from alkyl, heteroalkyl, cycloalkyl, heterocycloalkyl, aryl, heteroaryl and aralkyl which are optionally substituted. Preferred for R⁷ is hydrogen or alkyl, such as methyl, ethyl or propyl, and particularly preferred is hydrogen. A⁴ is selected from a phosphonate group —P(O)(OR¹¹)(OR¹²) and a phosphinoxide group —P(O)(R¹¹)(R¹²), wherein. R¹¹ and R¹² are independently selected from alkyl, cycloalkyl and aryl which are optionally substituted. Preferred is alkyl, particularly methyl, ethyl and propyl. R¹¹ and R¹² can be the same or different, but are preferably the same in view of the more convenient availability of such compounds. Furthermore, A⁴ can be selected from —S(O)(O)(OR¹¹), —S(O)(R¹¹) or —S(O)(O)(R¹¹), wherein R¹¹ has the same meaning as defined above. Preferred as A⁴ are the phosphonate group and the phosphinoxide group, and particularly preferred is the phosphonate group —P(O)(OR¹¹)(OR¹²).

The polymer chains may be homo- or copolymer chains. The copolymer chains may be random copolymers or block copolymers. Preferred as copolymers are block copolymers.

The polymer chains forming the polymer brushes in the claimed polymer modified substrates may include polymerized units formed from other monomers containing a polymerizable C—C double bond, e.g. olefins, apart from the vinyl monomers carrying a vinyl group substituted with an electron accepting group. However, it is preferred that the vinyl monomers carrying a vinyl group substituted with an electron accepting group, in particular those of formulae (IVa) and/or (IVb) above, provide at least 50 mol % of all polymerized units in each of the polymer chains attached to the binding layer in the polymer modified substrate, preferably at least 70 mol %, and in particular 100 mol %. Also in view of the ease of synthesis of the polymer chains, it may be convenient to form the polymer chains only by polymerization of vinyl monomers carrying a vinyl group substituted with an electron accepting group as defined above.

It will be understood that the composition of the polymer chains may be varied depending on the intended use of the polymer modified substrates in accordance with the invention. For certain uses, polymer chains containing the monomers of formula (IVa) above may be preferable, and the invention encompasses polymer brushes formed by polymer chains wherein at least 50 mol % of all polymerized units, preferably at least 70 mol %, and in particular at least 90 mol %, or all of the polymerized units, are provided by monomers of formula (IVa).

However, in view of the advantageous properties of phosphor containing polymers as indicated above, it is preferred that the polymer brushes comprised in the polymer-modified substrates in accordance with the invention contain units derived from monomers of formula (IVb) above, wherein A⁴ is selected from a phosphonate group —P(O)(OR¹¹)(OR¹²) and a phosphinoxide group —P(O)(R¹¹)(R¹¹)(R¹²), in particular the phosphonate group, in amounts of at least 10 mol %, preferably at least 20%, of all polymerized units.

In fact, it is preferable in the context of the invention that each of the polymer chains comprises at least 50 mol % of all polymerized units contained therein, preferably at least 70 mol %, and in particular at least 90 mol %, or all of the polymerized units, provided by monomers of formula (IVb) wherein A⁴ is selected from a phosphonate group —P(O)(OR¹¹)(OR¹²) and a phosphinoxide group —P(O)(R¹¹)(R¹²), and is in particular a phosphonate group. As indicated above, it is further preferred that the balance of the polymerized units is provided by other vinyl monomers carrying a vinyl group substituted with an electron accepting group, in particular by the vinyl monomers of formula (IVa). Thus, particularly preferred polymers forming the polymer chains in the context of the invention are polyphosphonate homopolymers or polyphosphonate/poly(meth)acrylate block-copolymers.

Having regard to the above, it should be mentioned that the invention also encompasses polymers containing acid groups in their free or neutralized form pending from the main chain of the polymer chains, which acid groups are obtainable via ester cleavage of the various ester groups contained in the monomers discussed above. Generally, the ester cleavage is conveniently carried out after the polymerization of the respective monomers. The resulting acid groups include carboxylic acid groups —COOH, phosphonic acid groups —P(O)(OH)₂, sulfonic acid groups —S(O)(O)(OH) or their salts with various cations, including alkaline metal cations, alkaline earth metal cations and ammonium ions.

The polymer chains forming the polymer brush contained in the claimed polymer-modified substrate are generally linear. They may be branched if suitable monomers providing a branching point are used, but unbranched polymers are preferred. It is preferred that the polymers chains in the brush are not crosslinked with each other.

The polymer brushes comprised by the polymer-modified substrates in accordance with the invention are formed by a plurality of polymer chains as defined above. Generally, the polymer brushes in accordance with the invention are formed by an assembly of at least 100, preferably at least 1000 polymer chains of this type.

While the polymer brushes may contain polymer chains other than polymer chains obtainable via polymerization of vinyl monomers carrying a vinyl group substituted with an electron accepting group as defined above, it is preferable in the context of the invention if the polymer brush is formed only by such polymer chains.

The thickness of the polymer layer on the surface of the substrate, e.g. determined via AFM or ellipsometry, is the sum of the thicknesses of the binding layer and the polymer brush. In accordance with the present invention, thicknesses of more than 60 nm, preferably more than 100 nm can be conveniently be prepared. For a typical thickness of the binding layer of e.g. 30 nm, polymer brush thicknesses of more than 30, preferably more than. 70 nm can thus be estimated.

Depending on the intended use of the polymer-modified substrate in accordance with the present invention, it is of course possible to further modify the polymer brushes, e.g. by first forming the polymer chains via the polymerization of monomers as described in further detail below, and subsequently further reacting the functional groups in the polymer chains. This strategy can be used e.g. to activate existing groups in order to increase their reactivity (e.g. as active esters), to provide specific functional groups (e.g. in the form of biological probes), or to attach additional materials to the polymer brush (e.g. polymeric materials such as polysaccharides, hydrogels etc.).

In accordance with the invention, the binding layer and the polymer brush described above allow various substrates to be modified by polymers. Suitable substrate materials which allow the attachment, in particular the covalent attachment of binder molecules include, for example, silica, alumina, glass, glassy carbon, diamond, polymer, metal (such as gold) or semiconductor (such as silicon) substrates. Suitable polymer substrates include, for example, polyolefins, such as polyethylene or polypropylene, polystyrene, polyamides or polyesters.

For the formation of the preferred binding layer from binder molecules carrying at least two vinyl groups each substituted by an electron withdrawing group, followed by surface grafting and polymerizing the binder molecules, it is advantageous if hydrogen atoms are present which are bound on the surface of the substrate to be modified. Exemplary substrates for this purpose are silicon, glass, glassy carbon, diamond and polymer substrates. During the surface grafting reaction of the binder molecules, the hydrogen atoms are abstracted, presumably via a radical mechanism, and a covalent bond is formed between the substrate and a vinyl group of a binder molecule or of the binding layer, respectively. Depending on the substrate material to be modified, it may be useful to subject the material to a preliminary cleaning step and/or a reduction reaction. For example, silicon substrates can be preliminarily treated to remove oxidic layers formed on the surface thereof. Due to the relatively weak Si—H bonds existing on the surface of such a silicon substrate, it can be conveniently used in the context of this preferred embodiment of the present invention. Furthermore, it is possible to purposively introduce surface groups, such as amino groups, providing hydrogen atoms which can be abstracted during the surface grafting and polymerization of the binder molecules to form a bond with the binder molecules.

The substrate can consist of the material forming the surface, but can also be a composite: material wherein all or part of the surface, e.g. a surface layer, is formed by a material suitable for the covalent attachment of binder molecules. The thickness of such a surface layer can be varied broadly, and layers of several cm can be used as well as monolayers which adhere to the surface, such as organic monolayers which provide hydrogen atoms for a subsequent reaction with the vinyl groups of the binder molecules. For example, silicon and glass surfaces can be provided with an intermediate monolayer formed by alkoxysilanes via known technologies for the modification of surfaces. If the silane carries a further group with an abstractable hydrogen atom, such as an amino group, the monolayer promotes the attachment of the binder molecules or the binding layer, respectively, to the substrate surface via surface grafting. Suitable alkoxysilanes are, for example, aminoalkyl timethoxysilanes or aminoalkyl triethoxysilanes.

However, using suitable binder molecules with functional groups adapted for a reaction with the surface of the substrate, it is also possible to prepare the binding layer without previous modification of the substrate surface.

The shape of the substrate to be modified is not limited. The modified area may be an extended planar surface as well as a shaped surface such as a sphere, a tube, a flask, or a plate with wells. In view of the fact that the polymer modified surfaces in accordance with the invention can be conveniently provided with polymer brushes of a high density and thickness, they are particularly useful to modify substrates with surface dimensions which are large compared to the thickness of the polymer brush. Frequently, the surface area on the substrate covered by the binding layer and the polymer brush has a size of at least 100 μm². However, it is of course also possible to apply the binding layer and the polymer brush to very small surface areas, such as nanoparticles.

In view of the fact that the polymer modification in accordance with the invention can provide excellent biocompatibility, exemplary substrates include those for medical or diagnostic applications, such as petri dishes, cell culture flasks, pipette tips, microcarriers, or microtiter plates. They also include spheres, and in particular microspheres, for various applications, such as microcarriers allowing for the growth of adherent cells, or spheres used as filter materials. However, the application of the invention is of course not limited to the medical or diagnostic area, and further includes industrial applications such as spheres, in particular microspheres modified with phosphorous containing polymers for compounding into various matrices in order to provide flame, retardant properties.

As noted above, the process of the present invention comprises the steps of
a) preparing on at least a part of the surface of the substrate a binding layer covalently attached to the substrate and carrying a plurality of vinyl groups substituted by an electron accepting group;
b) contacting the binding layer with a rare earth metal complexes as catalysts and allowing the rare earth metal in the complexes to coordinate with all or a part of the vinyl groups substituted by an electron accepting group of the binding layer;
c) contacting the binding layer including the coordinated rare earth metal complex catalysts with vinyl monomers containing a vinyl group substituted with an electron accepting group; and
d) carrying out a polymerization of the vinyl monomers mediated by the rare earth metal of the coordinated rare earth metal complex to form polymer chains covalently attached at one of their terminals to the binding layer.

In accordance with the preferred embodiment, the binding layer is prepared by a process wherein step a) comprises the steps
a1) of providing on the surface of the substrate binder molecules each carrying at least two vinyl groups each substituted by an electron accepting group; and
a2) of preparing the binding layer by surface grafting and polymerizing the binder molecules on the surface of the substrate.

For the formation of the binding layer, generally binder molecules are first provided on the surface. They can be applied to the surface either in neat form, particularly if they form liquids, or in the form of a solution in a suitable solvent. It will be understood that such a solvent should not interfere with the surface grafting and polymerization reaction. The application of the binder molecules or their solution to the surface can be achieved with conventional application and/or coating methods, including immersing the substrate into the binder molecules or a solution thereof, application with a brush, by spraying or via ink-jet-or other printing technologies.

After the binder molecules have been provided on the surface, they are covalently attached to the surface.

In accordance with the preferred embodiment using binder molecules each carrying at least two vinyl groups each substituted by an electron accepting group, a surface grafting and polymerization reaction is carried out for the formation of the binding layer and its attachment to the surface. As indicated above, the surface grafting reaction takes place between a vinyl group contained in the binder molecules and the surface of the substrate to form a covalent bond between the surface and the binder molecule. Without intending to be bound by theory, it is assumed that vinyl groups in the binder molecules, upon activation, form reactive species which are able to abstract a hydrogen atom from the surface of the substrate, i.e. the vinyl group could be considered as a sensitizer to activate a surface functional group by hydrogen abstraction. As a result of the hydrogen abstraction, a radical group remains at the surface which can start a free radical surface-initiated polymerization of the binder molecules. Since the binder molecules carry at least two reactive vinyl groups, the polymerization of the binder molecules can be accompanied by the formation of branched polymer chains and/or by a crosslinking reaction between the polymer chains formed from the binder molecules. Typically, the binding layer in accordance with this embodiment contains branched polymer chains. By increasing the number of vinyl groups, e.g. through the use of multifunctional binder molecules with more than two vinyl groups, the formation of crosslinks can be promoted. Thus, the binding layer can be formed in the surface grafting and polymerization reaction as an assembly of binder molecules polymerized in the form of a branched polymer and/or crosslinked polymer, preferably in the form of a branched polymer or a branched and crosslinked polymer, which is attached to the surface of the substrate. In this context, the term “network” is used to describe structures resulting from the formation of covalent crosslinks between polymer chains, structures resulting from the entanglement of branched chains as well as structures combining covalent crosslinks and branched chains.

Preferably, the surface grafting and polymerization reaction is started via activation of vinyl groups contained in the binder molecules by supplying energy, e.g. in the form of UV radiation or thermal energy. Activation using UV radiation is very convenient. The reaction is preferably started in the absence of any substances acting as initiators (such as typical polymerization starters). In this case, the reaction of the binder molecules can be referred to as self-initiated grafting and polymerization, or, specifically in the case of activation via UV radiation, as self-initiated photografting and photopolymerization (SIPGP) reaction.

The surface grafting and polymerization reaction can be carried out at room temperature or elevated temperatures. Preferably, binder molecules and any solvents which may be used should be degassed and dried in accordance with common practice. Especially in the case where the vinyl groups are activated by UV radiation, the reaction can be advantageously carried out at temperatures around room temperature, e.g. at 20 to 25° C. It is preferable to continue the supply of activating energy, e.g. the irradiation with. UV light, throughout the reaction. Regarding the wavelength of the UV light, it is advantageous to use UV light with a wavelength peak λₘₐₓ in the range of 300 to 380 nm, preferably at 350 nm. The reaction time is typically in the range of 1 min to 1 h, preferably in the range of 20 to 50 min. After the surface grafting and polymerization reaction, it is advantageous to thoroughly clean the resulting binding layer to remove unreacted binder molecules or polymers which are not covalently bound to the surface. For this purpose, conventional techniques such as washing with conventional solvents and/or pure water, optionally in combination with ultrasound can be used.

After the binding layer has been prepared the polymer chains forming the polymer brush are prepared. Generally, this is achieved via a polymerization reaction of the above described vinyl monomers in which the chains are grafted from the vinyl groups provided in the binding layer. It has been found that such a “grafting from” polymerization can be advantageously carried out in a reaction mediated by a rare earth metal complex catalyst. This type of polymerization reaction most likely proceeds via a group transfer mechanism and is also referred to herein as a “group transfer polymerization”. The formation of the polymer chains in the context of the invention preferably proceeds via such a group transfer polymerization (GTP), more specifically by a surface initiated group transfer polymerization (SIGTP), since the polymerization is initiated by rare earth metal complexes coordinated at the surface of the binding layer.

In a preliminary step of the polymerization reaction, the binding layer carrying a plurality of vinyl groups each substituted by an electron accepting group is contacted with the rare earth metal complex as a catalyst. The catalyst complexes are allowed to react with the vinyl grows substituted by an electron accepting group. This leads to a coordination of the rare earth metal complexes to the vinyl group substituted by an electron accepting group, specifically to the electron accepting group. It will be understood that the structure of the rare earth metal complex may change while the rare earth metal coordinates to the electron accepting group, since the electron accepting group typically replaces another ligand of the rare earth metal complex. Preferably, all of the vinyl groups carrying an electron accepting group in the binding layer are reacted with a rare earth metal complex.

Subsequently, the vinyl group containing monomers are added to the binding layer carrying the coordinated catalyst complexes to allow the polymer chains to grow from the binding layer. Without wishing to be bound to this theory, it is assumed that the polymer chain growth occurs via simultaneous coordination of an added monomer and the electron accepting group in the binding layer (or the growing chain end formed by previous polymerization steps) to the complex catalyst, followed by the transfer of the coordinated monomer to the covalently bound chain end. Thus, a new bond is formed either between the binding layer and a monomer or between a monomer derived unit of the growing polymer chain and a further monomer.

For details regarding the polymerization mechanism and suitable polymerization conditions, and on preferred catalyst complexes and their preparation, see S. Salzinger, U. B. Seemann, A. Plikhta, B. Rieger, Macromolecules 2011, 44, 5920-5927 and U. B. Seemann, J. E. Dengler, B. Rieger, Angew. Chem. Int. Ed. 2010, 49, 3489-3491 and U. B. Seemann, “Polyvinylphosphonate and deren Copolymere durch Seltenerdmetall initiierte Gruppen-Transfer-Polymerisation”, Dissertation, Technische Universität München, 2010.

For example, the substrate carrying the binding layer on a surface thereof can be placed in a solution containing the complex catalyst. Preferably, a non-polar solvent such as toluene is used. Concentrations of the rare earth metal complex catalyst which can be conveniently used are larger than 0.25 mg/ml, such as 0.5 to 1 mg/ml. The catalyst is allowed to coordinate with the binding layer for a certain period of time, typically in the range of 30 min to 2 hours. This coordination can be conveniently achieved at room temperature, e.g. in the range of 20 to 25° C. Subsequently, the monomer is added to the solution. Suitable amounts can be determined depending on the desired thickness of the polymer brush. If copolymer chains are to be produced, mixtures of different monomers can be added, or the polymerization reaction can be separated into subsequent stages in which different monomers are added. The growth of the polymer chains generally proceeds quickly within minutes at room temperature. Typical reaction temperatures are again within the range of 20 to 25° C. Typical reaction times range from 1 min to 30 min, preferably 1 min to 10 min. AFM investigations revealed an almost linear increase of the polyvinylphosphonate brush layer thickness with polymerization time.

The reaction should be carried out in an inert gas atmosphere. It can be terminated e.g. via addition of protic solvent, such as methanol.

The rare earth metal complex catalyst is preferably a catalyst comprising a metal selected from the group consisting of yttrium, gadolinium, terbium, dysprosium, holmium, erbium, thulium, ytterbium and lutetium; in particular from the group consisting of dysprosium, holmium, erbium, thulium, ytterbium and lutetium.

As far as the complex structure is concerned, complexes which have proven to be particularly useful are those of the following formula:

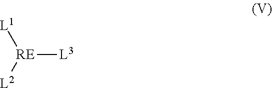

In this formula, RE is a rare earth metal, preferably a metal selected from the group consisting of yttrium, gadolinium, terbium, dysprosium, holmium, erbium, thulium, ytterbium and lutetium; in particular from the group consisting of dysprosium, holmium, erbium, thulium, ytterbium and lutetium.

L¹ and L² are independently selected from cyclopentadienyl, indenyl, and fluorenyl, which can be optionally substituted. The optional substituent(s) may be selected from halogen or alkyl, in particular methyl. Furthermore L¹ and L² may be bridged by a divalent alkyl or silyl moiety. Preferred groups L′ and L² are cyclopentadienyl and indenyl, in particular cyclopentadienyl.

L³ is selected from halogen, alkyl, optionally substituted cyclopentadienyl, optionally substituted indenyl or optionally substituted fluorenyl, an amide ligand, a thiol ligand, or an anionic silyl ligand. The optional substituents are the same as defined for L¹ and L² above. Preferred as L³ are methyl, ethyl, cyclopentadienyl, a S-t-butyl ligand or a CH₂-TMS ligand, in particular methyl or cyclopentadienyl.

Exemplary amide ligands have the formula —NR¹³R¹⁴, wherein R¹³ and R¹⁴ are independently selected from hydrogen, alkyl or cycloalkyl. Exemplary thiol ligands have the formula —SR¹⁵, wherein R¹⁵ is selected from hydrogen, alkyl or cycloalkyl, and exemplary anionic silyl ligand is —CH₂TMS, wherein TMS represents trimethylsilyl. The free valency indicated by the dash in these ligands indicates the coordinative bond linking the respective ligand as L³ to the rare earth metal.

Thus, complex catalysts which have been found to be particularly useful are Cp₂TmMe, Cp₃Tm, Cp₂YbMe, Cp₃Yb, Cp₂LuMe, and Cp₃Lu. It will be understood that “Cp” designates a cyclopentadienyl ligand, and “Me” a methyl ligand.

After the polymerization reaction has been successfully completed, the polymer chains can be further modified. For example, ester groups as they are provided in the polymer chains via polymerization of (meth)acrylates or vinylphosphonates can be subjected to a transesterification reaction. Similarly, such esters can be hydrolized to yield the corresponding free acid, or a salt thereof, depending on the pH of the surrounding medium. Regarding suitable conditions for the hydrolization of phosphonate esters, reference can be made to S. Salzinger, U. B. Seemann, A. Plikhta, B. Rieger, Macromolecules 2011, 44, 5920-5927.

The polymer-modified substrates in accordance with the present invention can be used for diverse applications, depending on the type of substrate and the nature of the polymer brush formed thereon. The modification can be used to impart to the substrate surface specific physical properties, or to provide a suitable surface for the attachment of further materials or molecules.

For example, polymer-modified substrates containing phosphorous atoms in the polymer brush, e.g. via polymerization or copolymerization of vinyl compounds of formula (IVb) above, are also advantageous in applications where flame retardant properties are required. For example, the binding layer and the polymer brush can be used to impart flame retardance to various surfaces. The substrates in accordance with the invention can also be used in the form of additives to be mixed with materials for which flame retardance is desirable.

Polymer-modified substrates carrying polymer brushes containing acid groups (such as phosphonic acid or (meth)acrylic acid groups or their salts) may further be used in applications where proton conductivity is required, e.g. as fuel cell membrane or on a fuel cell membrane, respectively.

Furthermore, polymer-modified substrates and especially those containing phosphorous atoms in the polymer brush, e.g. via polymerization or copolymerization of vinyl compounds of formula (IVb) above, are particularly advantageous in applications where biocompatibility and/or anti-fouling properties are required. The modified substrates in accordance with the invention can thus find applications in or as devices used for biological applications, such as medical or diagnostic applications. Examples of substrates include diverse flasks or vessels, such as petri-dishes, cell culture flasks, pipette tips, microcarriers, plates with wells (e.g. microtiter plates) and cover slips. Further possible applications include spheres, in particular microspheres as modified substrates which are used as filter materials, e.g. supported by a frit or filled into a cartridge. For example, the polymer-modification can be used to control the adhesion of bacteria, proteins, peptides, DNA and/or cells. Thus, the present invention also encompasses the use of the polymer modified substrates as substrates for the adhesion of biological materials such as bacteria, proteins, proteins, peptides DNA and/or cells (such as embryonic and adult stem cells, pluripotent cells and other cell types such as mesenchymal stromal cells), e.g. in the context of detection methods such as ELISA or PCR.

In a preferred embodiment, the invention also encompasses a process for the expansion of cells, comprising the step of contacting the cells with a polymer modified substrate in accordance with the invention, in particular a polymer-modified substrate containing phosphorous atoms in the polymer brush, e.g. via polymerization or copolymerization of vinyl compounds of formula (IVb) above. Due to their excellent biocompatibility, the modified substrates can be used to provide surfaces e.g. of cell-culture flasks or of microcarriers. Cells to which such a process can be applied are, for example, embryonic and adult stem cells, pluripotent cells and other cell types such as mesenchymal stromal cells.

Further interesting applications result from the fact that substrates modified with thermoresponsive polymer brushes can be provided in accordance with the invention. These are also useful for diverse biological and medical applications, e.g. as bacterial, protein, peptide, and/or cell adhesion mediators. Thus, it could be demonstrated that polymer brushes can be provided with defined hydrophilic or hydrophobic properties. For polymer brushes containing polymerized ester groups, such as polymerized vinylphosphonates and/or (meth)acrylates, these properties can be controlled by the nature of the group (formally the esterified alcohol group) pending from the polymer chain. For example, the influence of an alkyl chain length on the hydrophilic/hydrophobic character of a homopolymer brush formed by polymerizing vinylphosphonates can be shown by contact angle measurements. The polymerized hydrophilic dimethylvinyiphosphonate (DMVP) results in a static water contact angle (CA) of 17° (at room temperature, i.e. 20° C.), while the hydrophobic dipropylvinylphosphonate (DPVP) has a CA value of 76°. It has been found that the hydrophilic/hydrophobic properties of polymer chains, in particular of those which can be considered as being amphiphilic, change depending on the temperature of the surrounding medium. These polymer chains have thermoresponsive, or thermo-switching properties. For example, a substrate modified with polymerized diethylvinylphosphonate (DEVP) was found to have a static water CA of 44° at room temperature. However, the CA increased by 22° to 66° when the temperature was increased to 50° C. This thermo-switching was also found to be fully reversible. However, similar properties can be achieved also for polymer brushes formed from other monomers, such as N-alkyl substituted acrylamides (e.g. for N-diethyl acrylamide or N-propyl acrylamide).

For example, biocompatibility and thermoresponsive or thermo-switching properties can be exploited for the control of cell attachment and detachment under common cell culture conditions. The hydrophobic properties of polymer chains allow adhesion of cells, whereas the hydrophilic properties of polymer chains allow release of cells by avoiding the use of commonly used invasive detachment methods such as enzymes or scrapers. The release of cells by lowering the temperature is advantageous in applications where biological properties shall be conserved such as the adhesion and expansion of the above mentioned cells.

Other interesting applications of a polymer modified substrate with thermoresponsive properties can be found in the formation of intelligent polymers, or in separation chemistry, e.g. for substrates for gel permeation chromatography.

### EXAMPLES

### Materials

A Silicon (100) wafer was purchased from Wacker AG. Polystyrene microsphere was purchased from SoloHill Engineering, Inc. All chemicals were purchased from Sigma-Aldrich (Steinheim, Germany) or Acros (Geel, Belgium) and used as received unless otherwise stated. Toluene was dried using a MBraun SPS-800 solvent purification system. bis(Cyclopentadienyl) methyl ytterbium (Cp₂YbMe), Diethyl vinylphosphonate (DEVP) and Di-n-propyl vinylphosphonate (DPVP) were prepared according to literature procedures ((1). Leute, M. In Polymers with Phosphorus Functionalities, PhD Thesis, University of Ulm, Ulm, 2007; (2). Birmingham, J. M; Wilkinson, G. J. Am. Chem. Soc. 1956, 78, 42-44.) Dimethyl vinylphosphonate (DMVP) was purchased from Alpha Aesar. Monomers and 3-(Trimethoxysilyl)propyl methacrylate (TMSPM) were dried over calcium hydride and distilled prior to polymerization.

### Instruments

Infrared spectroscopy (IR) was performed using an IFS 55 Bruker instrument equipped with a diffuse reflectance Fourier transform infrared (DRIFT) setup from SpectraTech and a mercury-cadmium-telluride (MCT) detector. For each spectrum, 500 scans were accumulated with a spectral resolution of 4 cm⁻¹. Background spectra were recorded on bare oxidized silicon substrates.

Atomic force microscopy (AFM) scans were obtained with a Nanoscope IIIa scanning probe microscope from Veeco Instruments (Mannheim, Germany). The microscope was operated in tapping mode using Si cantilevers with a resonance frequency of 317 kHz, a driving amplitude of 1.35 V at a scan rate of 0.5 Hz.

Water contact angles were determined with a full automated Krüss DSA 10 Mk2 contact angle goniometer. The data were obtained with the aid of the Krüss Drop Shape Analysis v3 software package.

### Lower Critical Solution Temperature (LCST)

Turbidity measurements were carried out on a Cary 3 UV-vis spectrophotometer from Varian. The cloud point was determined by spectrophotometric detection of the changes in transmittance at λ=500 nm of the aqueous polymer solutions (1.0 wt %). The heating/cooling rate was 1.0 K min⁻¹ followed by a 5 min period of constant temperature to ensure equilibration. Given values for the cloud point were determined as the temperature corresponding to a 10% decrease in optical transmittance.

### Synthesis

### Poly(Dialkylvinyiphosphonate) Brushes on Hydrogen Terminated Silicon Substrates

### Hydrogen Terminated Silicon Substrate

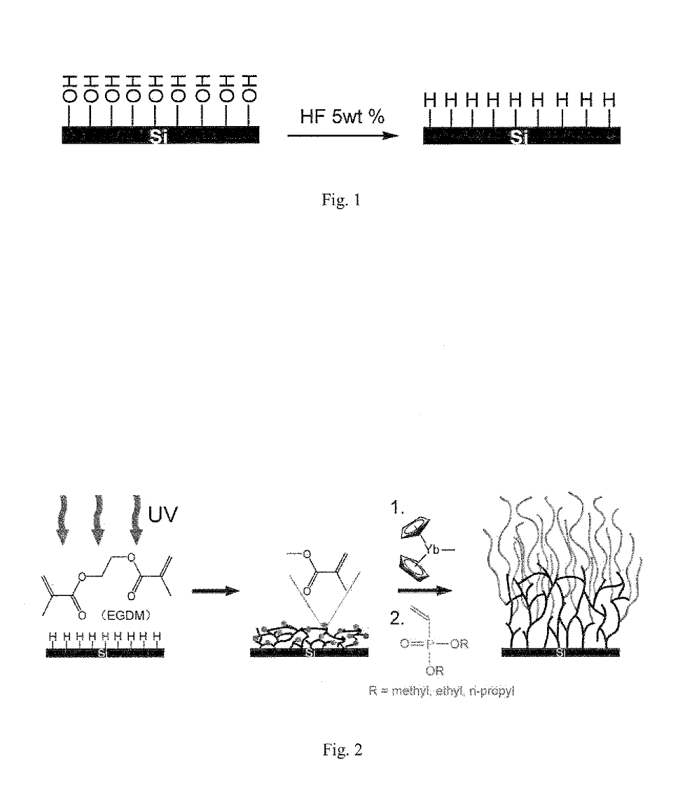

The silicon (100) substrates were first cleaned with a Piranha solution (H₂O₂ (35 wt. %)/H₂SO₄=⅓). Then, the silicon substrates were placed in a plastic vial with a 5 wt. % HF aqueous solution for 5 minutes to remove the oxidized silicon layer. After thorough cleaning by Millipore water and ethanol, the substrate was thoroughly rinsed by Millipore water and absolute ethanol. The obtained surface is illustrated in FIG. 1

### Poly(Ethylene Glycol Dimethacrylate) (PEGDM) Modified Silicon Substrate.

The hydrogen terminated silicon substrates were submerged in glass vials with degassed bulk ethylene glycol dimethacrylate (EGDM) for UV polymerization. In this manner, the self-initiated photografting and photopolymerization (SIPGP) of ethylene glycol dimethacrylate (EGDM) with UV-light was carried out with a UV light having a spectral distribution between 300 and 400 nm (λₘₐₓ=350 nm) (see J. Deng, W. Yang, B. Rånby, Macromol. Rapid Commun. 2001, 22, 535-538; M. Steenackers, S. Q. Lud, M. Niedermeier, P. Bruno, D. M. Gruen, P. Feulner, M. Stutzmann, J. A. Garrido, R. Jordan, J. Am. Chem. Soc. 2007, 129, 15655-15661; N. Zhang, M. Steenackers, R. Luxenhofer, R. Jordan, Macromolecules 2009, 42, 5345-5351). The reaction was allowed to proceed for 30 minutes. A maximum reaction time of 40 minutes was found favourable to avoid bulk gelation. After the UV irradiation, the samples were thoroughly cleaned by ultrasound in toluene, ethyl acetate, ethanol and Millipore water to remove unreacted monomer and physisorbed polymers. Binding layers obtained via this procedure are illustrated in FIG. 2.

As a result, a polymer layer with a network morphology could be formed. After the UV irradiation for 30 minutes, the substrate was vigorously cleaned by ultrasound in several solvents with different polarities to ensure that only chemically grafted polymer remains.

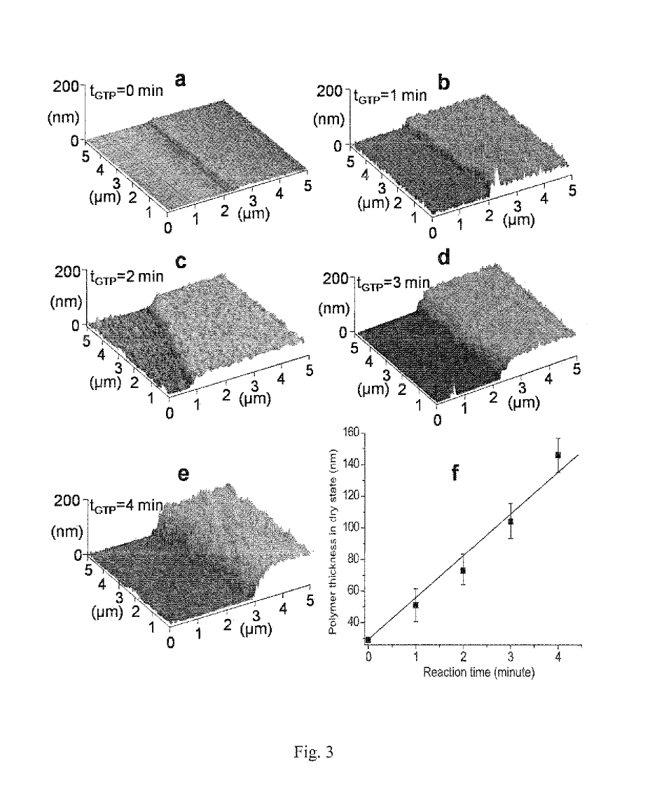

AFM measurements indicate that a 29±6 nm thick polymer layer was formed after SIPGP of EGDM (FIG. 3a).

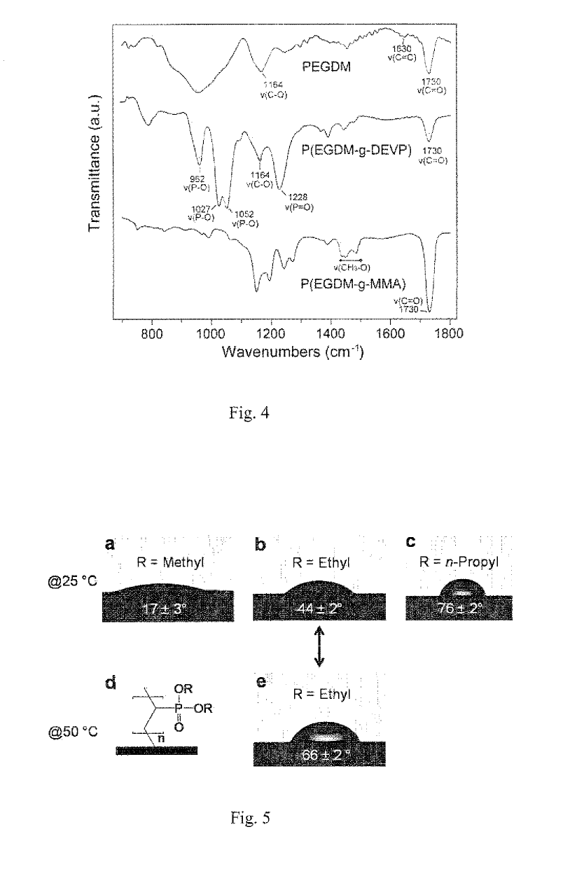

The successful modification of the silicon substrate by PEGDM was confirmed by infrared (IR) spectroscopy (FIG. 4). Strong bands at 1732 cm⁻¹ and 1164 cm⁻¹ were assigned to the (C═O) and the (C—O) stretching mode. A weak band at 1630 cm⁻¹ assigned to the (C═C) stretching mode indicates that part of the methacrylate groups are preserved after the UV polymerization, which allows the further functionalization of the binding layer.

### PEGDM Modified Substrate on APTMS Monolayers

Adapting the above procedure, PEGDM film can also be formed on silicon or glass substrates on which a 3-aminopropyl trimethoxysilane (APTMS) monolayer is applied. A self assembling monolayer (SAM) of APTMS was grown on silicon (100) substrate (with a thin oxidized layer) or glass slides by silanization of APTMS (5 wt %) in dry acetone for 2 hours. After the silanization, physisorbed molecules on the substrate were removed by ultrasonication in ethyl acetate, ethanol and. Millipore water for 2 minutes each.

Poly(Dialkylvinylphosphonate) Polymer or Copolymer Brushes on PEGDM Modified Silicon substrate

### Protocol:

The PEGDM modified silicon substrate was placed in a 3 mL toluene solution containing 1 mg Cp₂YbMe for 1 h at room temperature. Subsequently, 500 equivalents of dialkylvinyl phosphonate (DAVP) and/or methyl methacrylate (MMA) monomers were added to perform GTP. To stop the reaction, 0.4 mL methanol was added. The samples were thoroughly cleaned by ultrasonication in toluene, ethanol and Millipore water each for 2 minutes to remove monomer, physisorbed polymer and residues.

### Poly(Dialkylvinylphosphonate) Brushes on PEGDM Modified Silicon and Glass Substrates

The PEGDM modified silicon/glass substrate was placed in a 3 mL toluene solution containing 1 mg Cp₂YbMe for 1 h at room temperature. Subsequently, 500 equivalents (total amount of the comonomers) of vinylphosphonate comonomers (dimethylvinyl phosphonate, diethylvinyl phosphonate or dipropyivinyl phosphonate) were added to perform a group transfer polymerization (GTP). To stop the reaction, 0.4 mL methanol was added. The samples were thoroughly cleaned by ultrasonication in toluene, ethanol and Millipore water each for 2 minutes to remove monomer, physisorbed polymer and residues. Obtained polymer modified surfaces are illustrated in FIG. 2.

After the second polymerization, the successful grafting of DEVP on PEGDM was confirmed by IR spectroscopy again (FIG. 4). The band at 1630 cm⁻¹ assigned to (C═C) stretching disappeared completely and a new intensive band appeared at 1228 cm⁻¹ which is characteristic for the (P═O) stretching mode of the poly(vinylphosphonate)s.

The SIGTP of DEVP was terminated after different reaction times and the obtained polymer layer thicknesses revealed by AFM increased from 29±6 nm to 51±11, 73±9 104±11 and 146±12 nm after the polymerization was performed for 1, 2, 3 and 4 minutes respectively (FIG. 3a-e). Furthermore, as shown in FIG. 3f, the thickness of the polymer brush layer as measured by AFM under ambient conditions is plotted as a function of the polymerization time. An almost constant growth rate of 26.5 nm/minute is observed. This rapid and constant growth rate of the polymer layer is due to the efficient and living character of the GTP. The growth rate of layer thickness decreases for longer polymerization times (>6 min).

### Properties

The influence of the alkyl chain length on the hydrophilic/hydrophobic character of the polymer layer was investigated at room temperature by contact angle measurements. The hydrophilic DMVP results in a static water contact angle (CA) of 17°, while the hydrophobic DPVP has a CA value of 76°. The PDEVP modified substrate was found to have a static water CA of 44° at room temperature. However, the CA increased by 22° to 66° when the temperature was increased to 50° C. This thereto switching was also found to be fully reversible. The results of the contact angle measurements are shown in FIG. 5.

### Polydialkylvinylphosphonate of Polymethylmethacrylate Brushes on Microspheres

### Poly(Ethylene Glycol Dimethacrylate) (PEGDM) Modified Microcarriers

0.2 g Cross-linked polystyrene microcarriers were dispersed in 5 mL degassed bulk ethylene glycol dimethacrylate (EGDM) for UV polymerization. The UV light has a spectral distribution between 300 and 400 nm (λₘₐₓ=350 nm). The reaction was allowed to proceed for 30 minutes. After the UV irradiation, the samples were thoroughly cleaned by ultrasound in toluene, ethyl acetate, ethanol and Millipore water to remove unreacted monomer and physisorbed polymers.

### Poly(Dialkylvinylphosphonate) Brushes or Methylmethacrlyate Brushes on PEGDM Modified Microcarriers

0.2 g PEGDM modified microcarriers were placed in a 5 mL toluene solution containing 10 mg Cp₂YbMe for 1 h at room temperature. Subsequently, 500 equivalents of DAVP or MMA monomers were added to perform GTP. To stop the reaction, 0.4 mL methanol was added. The microcarriers were thoroughly cleaned in ultrasonication in toluene, ethanol and Millipore water each for 2 minutes to remove monomer, physisorbed polymer and residues.

### Poly(Methyl Methacrylate) Brushes on Hydrogen Terminated Silicon Substrates

Poly(methyl methacrylate) brushes can be synthesized accordingly on a PEGDM modified silicon substrate. Uniform and thick PMMA brushes (˜300 nm) can be prepared within minutes at room temperature. The successful synthesis of a PMMA brush on PEGDM film was confirmed by IR. As shown in FIG. 4, after the second grafting polymerization, a new band arising at 1485-1449 cm⁻¹ is assigned to the typical CH₃—O stretching mode of PMMA.

### Poly(Diethylvinylphosphonate) or Polymethylmethacrylate Brush on TMSPM Modified Silicon Substrate

Monolayer of 3-(Trimethoxysilyl)propyl methacrylate (TMSPM)

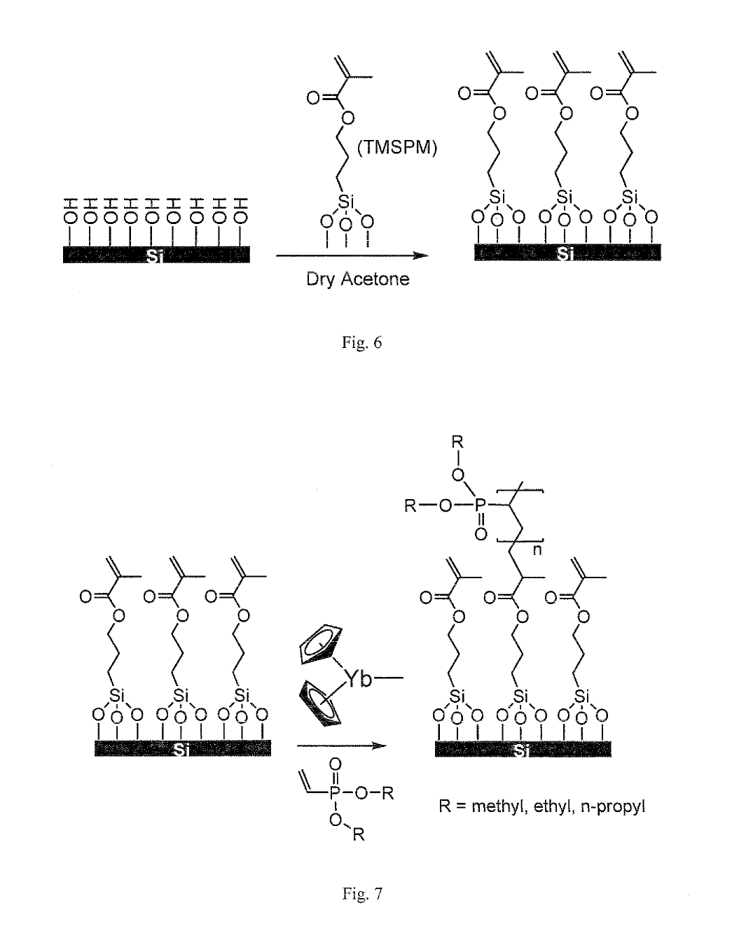

A self-assembled monolayer (SAM) of TMSPM was grown on silicon (100) substrate (with a thin oxidized layer) by silanization of TMSPM (5 wt %) in dry acetone for 2 hours. After the silanazation, physisorbed molecules on the substrate were washed away be ultrasound in ethyl acetate, ethanol and. Millipore water for 2 minutes each. The obtained monolayer is illustrated in FIG. 6.

### Formation of Polymer Brush

The TMSPM modified silicon substrate was placed in a 3 mL, toluene solution containing 1 mg Cp₂YbMe for 1 h at room temperature. Subsequently, 500 equivalents of DAVP or MMA monomers were added to perform group transfer polymerization (GTP). To stop the reaction, 0.4 mL methanol was added. The samples were thoroughly cleaned by ultrasonication in toluene, ethanol and Millipore water each for 2 minutes to remove monomer, physisorbed polymer and residues. The obtained polymer brush is schematically illustrated in FIG. 7.

AFM measurements on the obtained surface showed small dots formed on the substrate indicating a lower coverage of the substrate by the polymers than in the case of PEGDM binding layers. The low coverage may be caused by the densely packed. SAM of TMPMS as well as the bulky Cp₂YbMe, both of which limit the accessibility of methacrylate for the catalyst.

FIG. 1 illustrates the formation of a hydrogen terminated silicon substrate.

FIG. 2 illustrates the covalent immobilization of PEGDM network on a silicon wafer and the subsequent group transfer polymerization (GTP) of dialkylvinylphosphonates to form polymer brushes.

FIG. 3 shows AFM 3D images of a PEGDM film on a silicon wafer and polymer brushes after SIGTP of DEVP: (a) SIPGP of EGDM for 30 min gives PEGDM film with a thickness of 29±6 nm. (b)-(e) GTP of DEVP on the above PEGDM film for 1, 2, 3 and 4 minutes results in 51±11, 73±9, 104±11 and 146±12 nm thick polymer layer respectively. (f) Polymer layer thickness as a function of GTP time.

FIG. 4 shows IR spectra of PEGDM, P(EGDM-g-DEVP), and P(EGDM-g-MMA) brushes on a silicon wafer.

FIG. 5 shows the molecular structure of poly(dialkylvinylphosphonate)s (PDAVP) (d) and static water contact angle (CA) on different PDAVP coatings on silicon substrates at different temperatures. (a-c) CA of PDMVP, PDEVP and PDPVP brushes at 25° C. (e) CA of PDEVP brush at 50° C.

FIG. 6 illustrates the formation of a SAM of 3-(Trimethoxysilyl)propyl methacrylate (TMSPM) as a binding layer.

FIG. 7 shows the formation of polyvinyl phosphonate chains on the binding layer of FIG. 6.

1. A process for the preparation of a polymer-modified substrate, the process comprising the steps of
a) preparing on at least a part of the surface of the substrate a binding layer covalently attached to the substrate and carrying a plurality of vinyl groups substituted by an electron accepting group;
b) contacting the binding layer with rare earth metal complexes as catalysts and allowing the rare earth metal complexes to coordinate with the vinyl groups substituted by an electron accepting group of the binding layer;
c) contacting the binding layer including the coordinated rare earth metal complex catalysts with vinyl monomers containing a vinyl group substituted with an electron accepting group; and
d) carrying out a polymerization of the vinyl monomers mediated by the rare earth metal of the coordinated rare earth metal complex to form polymer chains covalently attached at one of their terminals to the binding layer.

2. The process of claim 1, wherein step a) comprises the steps of
a1) providing on the surface of the substrate binder molecules each carrying at least two vinyl groups each substituted by an electron accepting group; and
a2) preparing the binding layer by surface grafting and polymerizing the binder molecules on the surface of the substrate.

3. The process of claim 1, wherein the rare earth metal complex catalyst comprises a metal selected from the group consisting of yttrium, gadolinium, terbium, dysprosium, holmium, erbium, thulium, ytterbium, and lutetium.

4. The process of claim 1, wherein the rare earth metal complex catalyst is a trivalent rare earth metal complex comprising a rare earth metal atom coordinated by at least two cyclopentadienyl ligands.

5. The process of claim 2, wherein the binding layer is prepared using binder molecules which carry two (meth)acrylate groups as vinyl groups substituted with an electron accepting group.

6. The process of claim 5, wherein the binder molecules are alkyleneglycol dimethacrylates.

7. The process of claim 1, wherein the polymer chains comprise polymerized units selected from the group consisting of vinylphosphonate units, vinylphosphonic acid units, (meth)acrylate units, (meth)acrylic acid units and combinations thereof.

8. The process of claim 1, wherein the polymer chains comprise polymerized units selected from the group consisting of vinylphosphonate units, vinylphosphonic acid units, and combinations thereof.

9. A polymer modified substrate obtainable by the process of claim 1, said polymer-modified substrate comprising
(a) a substrate,
(b) a binding layer covalently attached to the surface of the substrate and covering at least a part of this surface; and
(c) a polymer brush formed by a plurality of polymer chains, each of which is covalently attached at one of its terminals to the binding layer.

10. The polymer modified substrate in accordance with claim 9, wherein the binding layer is obtainable by providing on the surface of the substrate binder molecules each carrying at least two vinyl groups substituted by an electron accepting group, and surface grafting and polymerizing the binder molecules on the surface of the substrate to form the binding layer.

11. A method of imparting flame retardant properties, anti-fouling properties, or biocompatibility comprising providing a polymer modified substrate as defined in claim 9.

12. A method of adhering cells, tissues and/or proteins to a substrate comprising:
providing a polymer modified substrate as defined in claim 9, and
adhering the cells, tissue and/or proteins to the polymer modified substrate.

13. A process for the expansion of cells, comprising the step of contacting the cells with a polymer modified substrate in accordance with claim 9.

14. The method of claim 12, wherein the cells are stem cells selected from the group consisting of embryonic and adult stem cells, pluripotent cells and mesenchymal stromal cells.

15. A binding-layer modified substrate comprising a substrate and a binding layer covalently attached to the surface of the substrate and covering at least a part of this surface, wherein the binding layer is obtainable by providing on the surface of the substrate binder molecules, each carrying at least two vinyl groups substituted by an electron accepting group and surface grafting and polymerizing the binder molecules on the surface of the substrate.

16. The process according to claim 13, wherein the cells are stem cells selected from the group consisting of embryonic and adult stem cells, pluripotent cells and mesenchymal stromal cells.
